(19) United States
(12) Patent Application Publication
(10) Pub. No.: US 2006/0064887 A1
(43) Pub. Date: Mar. 30, 2006

(54) Universal laser beam generating device

(76) Inventor: Shih-Chang Chang, Sinhua Township (TW)

Correspondence Address: Raymond Sun, 12420 Woodhall Way, Tustin, CA, 92782, US

(21) Appl. No.: 11/063,712

(22) Filed: Feb. 23, 2005

(30) Foreign Application Priority Data
Sep. 27, 2004 (TW) 93129166

(51) Int. Cl. G01C 15/00

(52) U.S. Cl. 33/286

(57) ABSTRACT

A universal laser beam generating device is provided with an automatic indication function. The laser beam generating device has a case, a laser beam generator, and a universal vial. The laser beam generator is positioned in the case to produce a laser beam, and the universal vial is arranged in the case to indicate the inclined angle between the laser beam and a reference plane.

### BACKGROUND OF THE INVENTION

1. Field of the Invention

The present invention relates to a laser beam generating device, and in particular, to a universal laser beam generating device having an automatic indication function.

2. Description of the Prior Art

It is common practice in architecture and decoration to use a laser beam generating device for projecting laser beam dots, straight lines, cross lines or a variety of other laser beams onto objects for the purpose of demarcating reference lines or planes. These laser beam generating devices may include a tubular vial or other horizontal sensor that function to detect the level or verticality of the laser beam.

For example, the conventional laser leveler projects a laser spot on a target. The conventional laser leveler is typically provided with at least a tubular vial which is parallel to the generated laser beam, so as to detect the level of the projected laser beam. Moreover, to extend its application, the conventional laser leveler can also be provided with a tubular vial that is perpendicular to the generated laser beam. Consequently, the laser beam can be generated perpendicular to the horizontal plane with greater convenience. If a tubular vial can be manually turned and a round dial is provided with the leveler, arbitrary angles can be set between the generated laser beam and the tubular vial, thereby extending the use of the laser leveler even further.

Unfortunately, this manual turning action may affect the precision of the laser leveler as well as render the operation to be inconvenient.

### SUMMARY OF THE INVENTION

It is an object of the present invention to provide a universal laser beam generating device which can automatically show the degree of inclination for the generated laser beam to enhance the precision of the angle measurement.

It is another object of the present invention to provide a universal laser beam generating device which can automatically show the degree of inclination for the generated laser beam to render the operation to be more convenient.

In order to accomplish the above mentioned and other objects, the present invention provides a universal laser beam generating device that has an automatic indication function. The laser beam generating device has a case, a laser beam generator, and a universal vial. The laser beam generator is positioned in the case to produce a laser beam, and the universal vial is arranged in the case to indicate the inclined angle between the laser beam and a reference plane.

### BRIEF DESCRIPTION OF THE DRAWINGS

FIG. 1 is a perspective view of a universal laser beam generating device in accordance with one embodiment of the present invention.

FIG. 2 is an exploded perspective view of the universal laser beam generating device shown in FIG. 1.

FIG. 3 illustrates the use of the universal laser beam generating device shown in FIG. 1.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

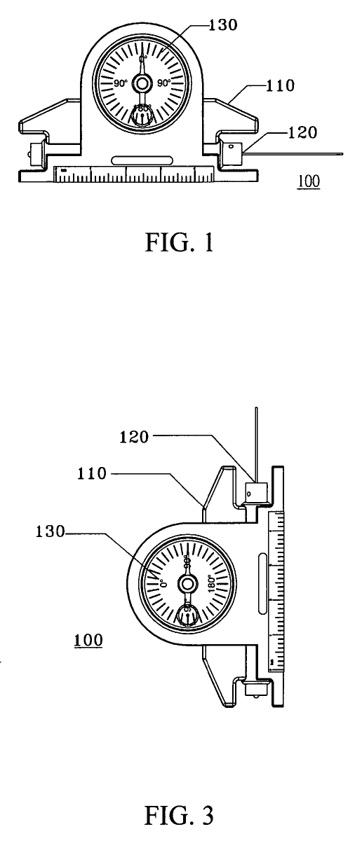

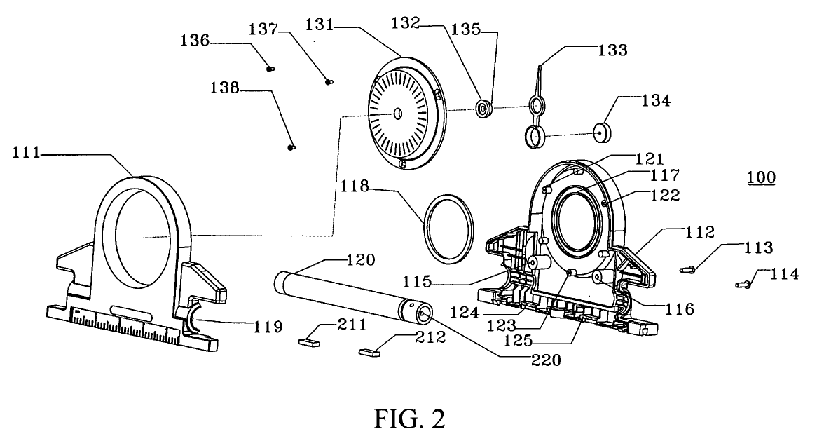

FIGS. 1 and 2 illustrate a universal laser beam generating device 100 in accordance with one embodiment of the present invention. Although the present invention is illustrated in connection with a laser leveler which can project a laser dot onto a target, the principles of the present invention are also applicable to any universal laser beam generating device, which can be provided with various types of laser generators to generate various types of laser, such as laser dots, laser lines, cross laser lines and others.

As shown in FIGS. 1 and 2, the universal laser beam generating device 100 includes a case 110, a laser beam generator 120, and a universal vial 130. The case 110 includes a left cover 111 and a right cover 112 that are connected together by screws 113 and 114. The screws 113 and 114 extend through holes 115 and 116, respectively, in the right cover 112 to be secured to corresponding screw holes (not shown) in the left cover 111. The universal vial 130 includes a round dial 131 which is secured by screws 136, 137 and 138 to screw holes 121, 122 and 123, respectively, on the right cover 112. The universal vial 130 also includes a bearing 132 and a plumb pointer 133. The bearing 132 is secured to the round dial 131, and the plumb pointer 133 is pivotably coupled to the round dial 131 via an axis 135 defined by the bearing 132. The plumb pointer 133 has a magnet 134 fitted at its lower end, and typically oscillates in a pendulous manner under the influence of gravity. A damping mechanism is provided to enable the plumb pointer 133 to quickly reach a stable condition after its pendulous oscillation. The damping mechanism includes a copper stop ring 118 that works together with the magnet 134. The copper stop ring 118 is provided in a ring notch 117 on the right cover 112.

The laser beam generator 120 is positioned in an accommodating space 119 formed between the left cover 111 and the right cover 112. The laser beam generator 120 generates a laser beam to project a laser dot on to an object. A variety of types of laser beam generators 120 can be provided for use with the universal laser beam generating device 100. For example, a lens 220 can be arranged in the laser beam generating device 220 to transform the generated laser beams into horizontal or vertical laser planes, thereby projecting horizontal or vertical laser lines on to targets. In addition, optical devices (not shown) which can project laser beams on the ground can also be provided in the laser beam generating device 100 to further extend its application.

Magnets 211 and 212 are arranged in respective accommodating spaces 124 and 125 formed on the bottom of the left cover 111 and the right cover 112, respectively. Consequently, when the universal laser beam generating device 100 is in use, the magnets 211 and 212 function to attract the universal laser beam generating device 100 to a supporting element (e.g., such as a metal tube for a pipe on which the device 100 is placed for measurement) to make the operation more convenient.

In operation, if a laser beam parallel to the horizontal plane is required for reference, the universal laser beam generating device 100 is positioned horizontally as shown in FIG. 1 so that the plumb pointer 133 would point to the zero degree position (with respect to a horizontal axis) on the dial 131, thereby allowing the universal laser beam generating device 100 to produce a laser beam that is parallel to the horizontal plane.

If a laser beam perpendicular to the horizontal plane is required for reference, the universal laser beam generating device 100 is rotated about ninety degrees as shown in FIG. 3, so that the plumb pointer 133 would point to a ninety-degree position on the dial 131 in accordance with gravity, thereby allowing the universal laser beam generating device 100 to produce a laser beam that is perpendicular to the horizontal plane.

Consequently, the universal laser beam generating device 100 can be manipulated by users to produce a laser beam at any desired angle that is inclined to a reference plane such as a horizontal plane. In this manner, the precision in measuring the degree of inclination can be improved, and users can operate the device 100 very conveniently.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A laser beam generating device, comprising:
a case;
a laser beam generator positioned in the case to produce a laser beam; and
a universal vial arranged in the case to indicate the inclined angle between the laser beam and a reference plane.

2. The device of claim 1, wherein the universal vial comprises:
a dial;
a bearing connected to the dial; and
a plumb pointer coupled to the bearing to oscillate with respect to the dial under the influence of gravity.

3. The device of claim 2, further comprising a stop ring and a magnet provided on the plumb pointer.

4. The device of claim 3, wherein the stop ring is made of copper.

5. The device of claim 1, wherein the universal vial is secured to the case by screws.

6. The device of claim 1, wherein the case comprises a left cover and a right cover.

7. The device of claim 1, further comprising a magnet provided on the bottom of the case.

8. The device of claim 1, wherein the laser beam generator further comprises a lens to transform a laser beam into a laser plane.

9. The device of claim 1, wherein the reference plane is the horizontal plane.

10. A laser beam generating device, comprising:
a case;
a laser beam generator positioned in the case to produce a laser beam; and
a universal vial having:
a dial;
a bearing connected to the dial;
a plumb pointer coupled to the bearing to oscillate with respect to the dial under the influence of gravity so as to indicate the inclined angle between the laser beam and a horizontal plane; and
a stop ring and a magnet provided on the plumb pointer.
